(19) United States
(12) Patent Application Publication
(10) Pub. No.: US 2011/0084895 A1
(43) Pub. Date: Apr. 14, 2011

(54) PLASMA DISPLAY DEVICE

(76) Inventors: Su-Jun Park, Yongin-si (KR); Seung-Hun Chae, Yongin-si (KR)

(21) Appl. No.: 12/869,722

(22) Filed: Aug. 26, 2010

(30) Foreign Application Priority Data
Oct. 13, 2009 (KR) 10-2009-0097315

(51) Int. Cl. G09G 3/28

(52) U.S. Cl. 345/60

(57) ABSTRACT

A plasma display device including: a plasma display panel including a plurality of electrodes; a printed circuit board assembly (PBA) activating the plasma display panel (PDP); a chassis base, including: a first surface supporting the plasma display panel (PDP), and a second surface having the printed circuit board assembly (PBA); signal lines applying a voltage, a data signal, and a control signal to the electrodes are formed at the end of the plasma display panel (PDP); and an interface flexible printed circuit connecting the signal lines to the printed circuit board assembly (PBA), wherein at least one of the signal lines has a line width at a portion further from the interface flexible printed circuit (FPC) that is larger than a line width at a portion closer to the interface flexible printed circuit (FPC).

### CROSS-REFERENCE TO RELATED APPLICATIONS

This application claims the benefit of Korean Patent Application No. 10-2009-0097315, filed Oct. 13, 2009, in the Korean Intellectual Property Office, the disclosure of which is incorporated herein by reference.

### BACKGROUND

1. Field

The described technology relates generally to a plasma display device of which the address buffer board assembly is removed or reduced in size, and a portion of the removed components are formed in a plasma display panel (PDP).

2. Description of the Related Art

In general, plasma display devices include a plasma display panel (PDP) that displays an image, a chassis base that supports the PDP, and printed circuit board assemblies (PBAs) mounted on the chassis base.

Among the PBAs, an address buffer board assembly is connected to a flexible printed circuit (FPC) that receives a voltage and a control signal from a power supply board assembly and a logic board assembly, respectively, and then applies them to address electrodes included in the PDP through a tape carrier package (TCP).

Furthermore, the power supply board assembly applies an address voltage to the address buffer board assembly. The logic board assembly applies a driver integrated circuit (IC) operation voltage, a driver IC control signal, a clock signal, and an address data signal to the address buffer board assembly. The address buffer board assembly controls the selected address electrodes in response to the signals.

In order to simplify the configuration and reduce the manufacturing cost of the plasma display device, the address buffer board assembly should be removed or reduced in size. In order to do so, the functions of components that are removed are re-configured in the plasma display device.

The above information disclosed in this Background section is only for enhancement of understanding of the background of the described technology and therefore it may contain information that does not form the prior art that is already known in this country to a person of ordinary skill in the art.

### SUMMARY

Aspects of the present invention provide a plasma display device that is formed such that components having functions relating to a removed or size-reduced address buffer board assembly are re-configured in the plasma display device.

Aspects of the present invention relate to a plasma display device including signal lines at an end of a PDP, which connect address electrodes with a newly formed integration board assembly instead of an address buffer board assembly, by including a portion of components having functions relating to removal/reduction to a logic board assembly.

Aspects of the present invention also relate to a plasma display device that reduces an increase of impedance due to an increase of an application distance by sequentially connecting signal lines formed at an end of a PDP to a flexible printed circuit (FPC) to reduce the number of signal lines passing through the flexible printed circuit (FPC) such that the line width of the other signal lines correspondingly increases.

According to an aspect of the present invention, a plasma display device includes: a plasma display panel including a plurality of electrodes; printed circuit board assembly activating the plasma display panel; a chassis base including: a first surface supporting the plasma display panel, and a second surface having the printed circuit board assembly; signal lines applying a voltage, a data signal, and a control signal to the electrodes are formed at the end of the plasma display panel; and an interface flexible printed circuit connecting the signal lines to the printed circuit board assembly, wherein at least one of the signal lines has a line width at a portion further from the interface flexible printed circuit that is larger than a line width at a portion closer to the interface flexible printed circuit.

According to another aspect of the present invention, the larger the number of signal lines passing through corresponding ones of flexible printed circuits from the interface flexible printed circuit is, the more the number of the signal lines decreases as the signal lines pass through the corresponding ones of the flexible printed circuits, and in accordance with the decrease of the number of signal lines, at least one of the signal lines remaining after passing through the corresponding ones of the flexible printed circuits may have a line width that increases after passing through the corresponding ones of the flexible printed circuits.

According to another aspect of the present invention, at least one of the signal lines may have a line width that increases in a step shape while passing through corresponding one of flexible printed circuits.

According to another aspect of the present invention, a signal line adjacent to the signal line having the step shape may have an expanding portion that increases a line width of the adjacent signal line after the corresponding ones of the flexible printed circuits.

According to another aspect of the present invention, at least one of the signal lines may have a trapezoidal shape with a line width that increases while passing through the corresponding ones of the flexible printed circuits.

Aspects of the present invention provide a plasma display including: a plasma display panel (PDP), including: a front substrate, a rear substrate, a plurality of electrodes between the front substrate and the rear substrate, and signal lines formed on the rear substrate apart from the plurality of electrodes and applying a voltage, a data signal, and a control signal to the electrodes; a chassis base adjacent to the rear substrate; a plurality of printed circuit board assemblies mounted on the chassis base; and an interface flexible printed circuit connecting the signal lines to corresponding ones of the printed circuit board assemblies, wherein at least one of the signal lines has a line width at a portion further from the interface flexible printed circuit that is larger than a line width at a portion closer to the interface flexible printed circuit.

Aspects of the present invention provide a plasma display device including: a plasma display panel including a plurality of electrodes; a printed circuit board assembly activating the plasma display panel and including: a sustain board assembly, a scan board assembly, a logic board assembly, a miniboard assembly, and a power supply board assembly; a chassis base supporting the plasma display panel at a first surface and having the printed circuit board assembly at a second surface; signal lines applying a voltage, a data signal, and a control signal to an address electrode and formed at the end of the plasma display panel; an interface flexible printed circuit connecting the signal lines to the miniboard assembly; and a flexible printed circuit having a driver IC mounted thereon, the flexible printed circuit connecting the signal lines to the address electrode, wherein the miniboard assembly is connected to the logic board assembly and controls an address electrode in the electrodes, and wherein at least one of the signal lines has a line width at a portion further from the interface flexible printed circuit that is larger than a line width at a portion closer to the interface flexible printed circuit.

According to another aspect of the present invention, a portion of components having functions relating to removing/reducing an address buffer board assembly are formed at the end of a plasma display panel (PDP), such that the configuration of a plasma display device is simplified and the manufacturing cost is reduced. That is, the manufacturing cost is reduced by forming signal lines connecting an integration assembly with address electrodes at the end of the PDP, which is not used in the related art.

According to another aspect of the present invention, since the signal lines formed at the end of the PDP are sequentially connected to flexible printed circuits (FPCs), the number of signal lines decreases across the flexible printed circuit (FPC) while at least one of the other signal lines is increased in width, thereby reducing an increase of impedance due to an increase of an application distance from a signal source.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view schematically showing an exploded plasma display device according to an exemplary embodiment of the present invention;

FIG. 2 is a cross-sectional view taken along the line II-II of FIG. 1;

FIG. 3 is a front upper perspective view of the PDP show in FIG. 1;

FIG. 4 is view illustrating a connection between signal lines formed at the end of the PDP shown in FIG. 3 and a flexible printed circuit (FPC);

FIG. 5 is a top plan view schematically showing the pattern of signal lines of which the line width changes, corresponding to flexible printed circuits (FPC), in a plasma display device according to another exemplary embodiment;

FIG. 6 is a top plan view schematically showing signal lines of which the line width changes, corresponding to flexible printed circuits (FPC), in a plasma display device according to yet another exemplary embodiment;

FIG. 7A and FIG. 7B are photographs showing an increase of the line width of the signal lines corresponding to a decrease of the number of signal lines; and

FIG. 8 is a rear view of a chassis base in a plasma display device according to another exemplary embodiment of the present invention.

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

As referred to herein, it is to be understood that where is stated herein that one film or layer is “formed on” or “disposed on” a second layer or film, the first layer or film may be formed or disposed directly on the second layer or film or there may be intervening layers or films between the first layer or film and the second layer or film. Further, as used herein, the term “formed on” is used with the same meaning as “located on” or “disposed on” and is not meant to be limiting regarding any particular fabrication process.

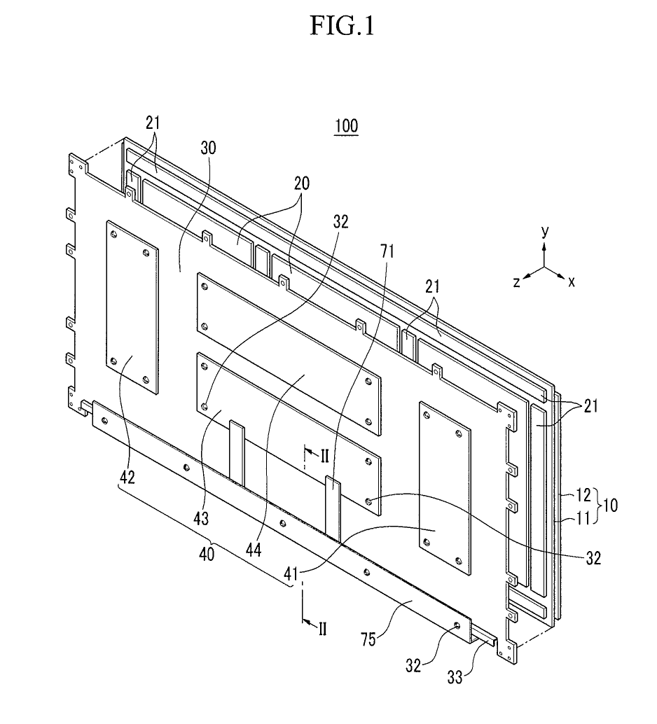

FIG. 1 is a perspective view schematically showing an exploded plasma display device according to an exemplary embodiment of the present invention. Referring to FIG. 1, a plasma display device 100 includes a PDP 10 that displays an image using gas discharge, a heat dissipation sheet 20, a chassis base 30, and printed circuit board assemblies (PBAs) 40.

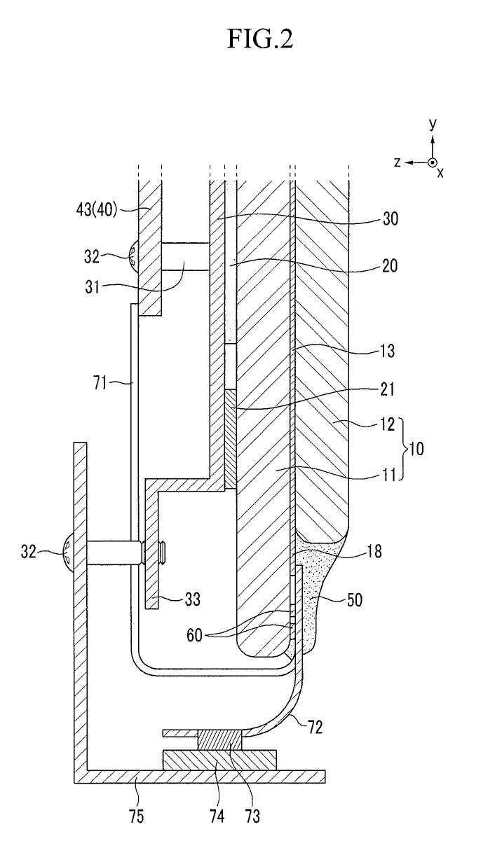

FIG. 2 is a cross-sectional view taken along the line II-II of FIG. 1. With reference to FIG. 2, the PDP 10 includes a rear substrate 11 and a front substrate 12 that are made of glass, and electrodes, for example, sustain electrodes and scan electrodes (not shown) to generate gas discharge between the rear substrate 11 and the front substrate 12, and address electrodes 13.

The heat dissipation sheet 20 is disposed between the PDP 10 and the chassis base 30, and rapidly diffuses heat generated by gas discharge from the PDP 10. The chassis base 30 supports the PDP 10 and is attached to the rear substrate 11 of the PDP 10 by a double-sided tape 21, with the heat dissipation sheet 20 therebetween.

Returning to FIG. 1, PBAs 40 are configured to be able to activate the PDP 10 and are electrically connected (not shown) to the PDP 10. For example, the PBAs 40 include a sustain board assembly 41, a scan board assembly 42, an integration board assembly 43, and a power supply board assembly 44.

The sustain board assembly 41 is connected to the sustain electrodes (not shown) through a flexible printed circuit (FPC) to control the sustain electrodes. The scan board assembly 42 is connected to the scan electrodes (not shown) through the FPC to control the scan electrodes. The integration board assembly 43 receives a video signal from the outside, and generates and selectively applies control signals to activate the address electrode 13, the sustain electrode, and the scan electrode of corresponding assemblies. The power supply board assembly 44 supplies power to activate the board assemblies.

Unlike the related art, the present exemplary embodiment of the present invention is not specifically provided with an address buffer board assembly to control the address electrodes 13. That is, the PBAs 40 do not include an address buffer board assembly.

Returning to FIG. 2, the PDP 10 is attached to a first side, i.e., a front side of the chassis base 30, and the PBAs 40 are mounted on a second side, i.e., a rear side of the chassis base 30. The PBAs 40 (including the integration board assembly 43 is shown in FIG. 2) are disposed on a plurality of bosses 31 of the chassis base 30, and are fastened to the chassis base 30 by setscrews 32.

As described above, since an address buffer board assembly is removed, the components involved in the function of the address buffer board assembly are configured in and added to a logic board assembly of the related art. Consequently, the integration board assembly 43 is accomplished.

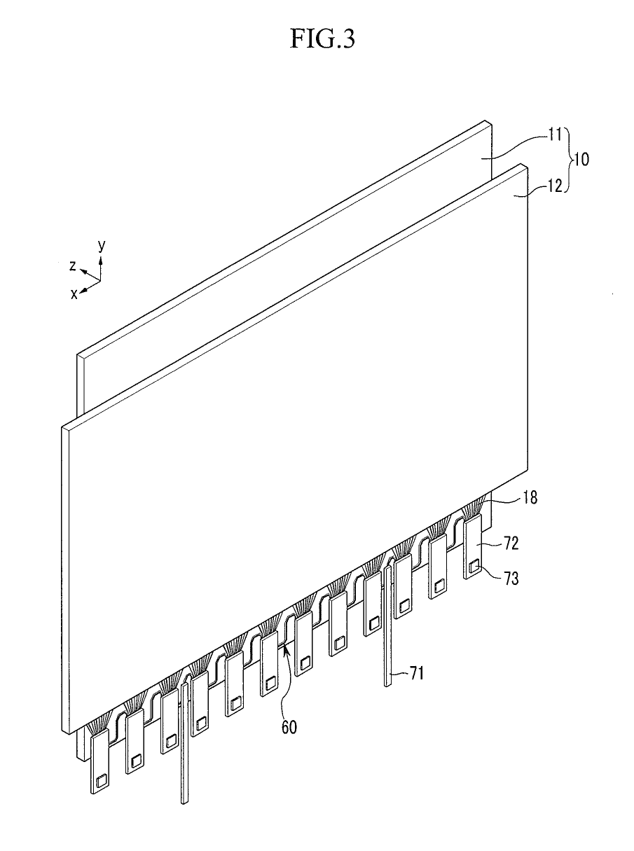

Comparing the present exemplary embodiment with the related art having an address buffer board assembly, the address electrode 13 should be controlled well in the present exemplary embodiment. For this purpose, signal lines 60 are disposed at an end of the PDP 10, and an interface FPC 71 connects the integration board assembly 43 with the signal lines 60 (see FIG. 3). The interface FPC 71 is connected to the integration board assembly 43 by a connector (not shown). However, aspects of the present invention are not limited thereto and the interface FPC 71 may be connected to the integration board assembly 43 using other methods such as being directly connected by a hot press.

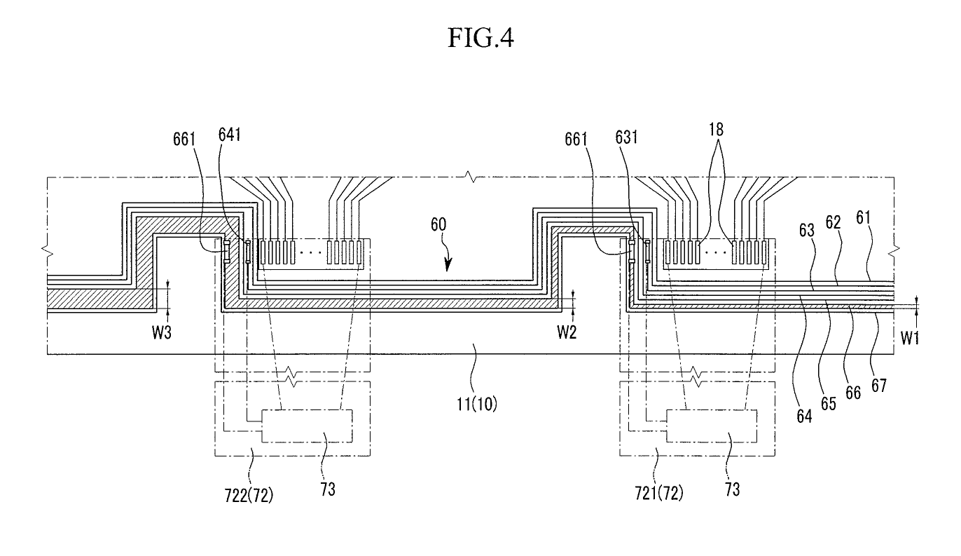

FIG. 3 is a front upper perspective view of the PDP 10 shown in FIG. 1, and FIG. 4 is view illustrating connection between signal lines formed at an end of the PDP 10 and a flexible printed circuit (FPC). Referring to FIG. 3 and FIG. 4, the signal lines 60 are formed at a portion of the PDP 10 that is not used, and more specifically, an end of the rear substrate 11 that is not used.

The signal lines 60 and the interface FPC 71 provide an electrical connection between the integration board assembly 43 and the address electrodes 13 in order to allow the integration board assembly 43 to control the address electrodes 13. Furthermore, a tape carrier package (TCP) 72 includes a driver IC 73 and is connected to the signal lines 60 at one end and the address electrodes 13 at the other end.

Accordingly, the interface FPC 71 applies the signals of the integration board assembly 43, which include a voltage, a data signal, and a control signal, to the signal lines 60. The signals applied to the signal lines 60 by the TCP 72 are then applied to the driver IC 73, and then the TCP 72 selectively applies address voltages and control signals generated from the driver IC 73 in accordance with the above signals to the address electrodes 13 through the address electrode terminals 18. As described above, the address electrodes 13 can be controlled by the integration assembly 43 and the driver IC 73.

In the plasma display device 100 of the present exemplary embodiment, the entire configuration is simplified because an address buffer board assembly is removed and components having functions involved in the address board assembly are formed at the ends of the integration board assembly 43 and the PDP 10. In other words, components having functions involved in the address board assembly are formed at the end of the rear substrate 11.

The signal lines 60 are connected to at least one interface FPC 71, and the present exemplary embodiment illustrates two interface FPCs 71 (see FIG. 1 and FIG. 3) that are connected to the signal lines 60. However, aspects of the present invention are not limited thereto, and the number of interface FPCs 71 may vary. The interface FPC 71 applies various signals of the integration board assembly 43 to the signal lines 60. Furthermore, the TCP 72 applies a signal of the driver IC 73 that is activated by the signals of the signal lines 60 to the address electrodes 13 through the address electrode terminals 18.

The farther the signal lines are from the portions connected with the interface FPC 71, which is a signal source, the more the impedance of the signal lines 60 increases. In order to stably activate the PDP 10, the increase of the impedance of the signal lines 60 needs to be maintained as low as possible, even though the distance from the interface FPC 71 increases.

For this purpose, in the present exemplary embodiment, at least one of the signal lines 60, such as the first signal line 61, has two or more line widths. For example, one of the signal lines 60 has a narrow line width at a portion close to the interface FPC 71, and has an increased line width as the length of the one of the signal lines 60 increases. Such an increased line width is illustrated in FIG. 4, wherein the interface flexible printed circuit (FPC) 71 is connected at the right side in FIG. 4.

Referring to FIG. 4, the TCP 72 disposed on the right side with reference to FIG. 4 is referred to as a first TCP 721. The TCP 72 disposed on the left side with reference to FIG. 4 is referred to as a second TCP 722. The first TCP 721 and second TCP 722 connect associated ones of the signal lines 60 to corresponding address electrode terminals 18.

Seven of the signal lines 60, first to seventh signal lines 61, 62, 63, 64, 65, 66, and 67, are connected to the interface FPC 71 in a pattern at the end of the rear substrate 11. However, aspects of the present invention are not limited thereto and other amounts of signal lines 60 may be connected to the interface FPC 71.

The first to fifth and the seventh signal lines 61, 62, 63, 64, 65, and 67 apply individual signals to the TCPs 72, respectively, and the sixth signal line 66 applies a common signal, that is, an address voltage, to the TCPs 72. Therefore, the first to fifth and the seventh signal lines 61, 62, 63, 64, 65, and 67 are selectively connected to respective ones of the TCPs 72, and the sixth signal line 66 is connected to all the TCPs 72.

For example, the first TCP 721 is connected to terminals 631 and 661 of the third and sixth signal lines 63 and 66, and receives signals while being connected to the address electrode terminals 18 and applying a control signal outputted from the driver IC 73 to the address electrodes 13 through the address electrode terminals 18. As the third signal line 63 ends at the first TCP 721, the sixth signal line 66 passing through the first TCP 721 has a second line width W2 that is larger than the prior first line width W1. However, aspects of the present invention are not limited thereto, and other signal lines may end at the first TCP 721 and other signal lines may have an increased line width.

Furthermore, the second TCP 722 is connected to terminals 641 and 661 of the fourth and sixth signal lines 64 and 66, and receives signals while being connected to the address electrode terminals 18 and applying a control signal outputted from the driver IC 73 to the address electrodes 13 through the address electrode terminals 18. As the fourth signal line 64 ends at the second TCP 722, the sixth signal line 66 passing through the second TCP 722 has a third line width W3 that is lager than the second line width W2 passing through the first TCP 721.

As described above, as the signal lines start from the interface FPC 71, which supplies a source signal, and pass through the TCPs 72, the number of signal lines 60 decreases, however, the area in which the signal lines 60 are formed remains the same size. Accordingly, the area extending to the end of the rear substrate 11 and available for the remaining of the signal lines 60 after passing through the TCPs 72 increases. Thus, at least one of the signal lines 60 remaining after passing through one of the TCPs 72 can be increased in line width.

In the signal lines 60, the sixth signal line 66 can minimize an increase of impedance due to the distance of the signal application point increasing by the increasing size of the first, second, and third line widths W1, W2, and W3. That is, the increase of the impedance due to the increase of the signal application distance is reduced by the increase of the line width. Accordingly, the PDP 10 can be stably activated.

Furthermore, the increased space at the end of the rear substrate 11 that is available because of the decrease of the number of signal lines 60 makes it possible to increase the line width of the sixth signal line 66, and to also increase the line width of the sixth signal line 66 and another signal line. However, aspects of the present invention are not limited thereto and other signal lines may be increased in line width.

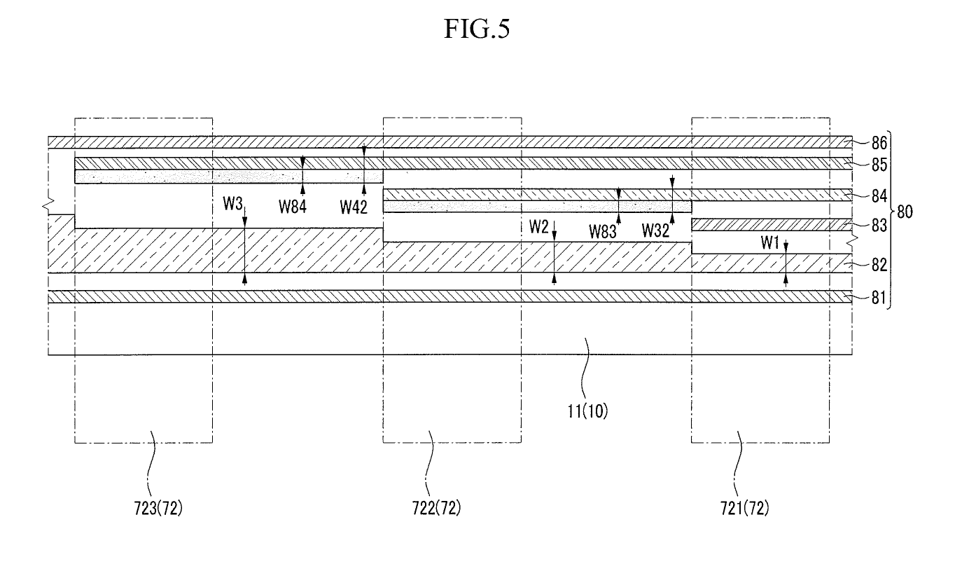

FIG. 5 is a top plan view schematically showing the pattern of signal lines of which the line width changes, corresponding to flexible printed circuits (FPCs), in a plasma display device according to another exemplary embodiment. For convenience, in FIG. 5, the connection structure between the TCPs 72 and the address electrode terminals 18 is not shown, and the number of signal lines 80 decreases and the width of the signal lines 80 increases after passing through the TCPs 72. The signal lines 80 include first to sixth signal lines 81, 82, 83, 84, 85, and 86, and the TCPs 72 include first to third TCPs 721, 722, and 723.

According to the present embodiment, one of the signal line 82 has a line width that increases in a step shape while passing through the first to third TCPs 721, 722, and 723. That is, since the third signal line 83 is connected to and ends at the first TCP 721, the second signal line 82 has a first line width W1 up to the first TCP 721 and a second line width W2 after the first TCP 721 that is greater than the first line width W1. Furthermore, since the fourth signal line 84 is connected to and ends at the second TCP 722, the second signal line 82 has the second line width W2 up to the second TCP 722 and a third line width W3 after the second TCP 722 that is greater than the second line width W2.

Also, the line width of the fourth signal line 84 increases while the line width of the second signal line 82 increases. For example, the fourth signal line 84 increases in line width from a first line width W1 to a thirty-second line width W32 after passing through the first TCP 721. That is, the thirty-second line width W32 includes an expanded portion W83 in addition to the first line width W1. Furthermore, the fifth signal line 85 increases from the first line width W1 to a forty-second line width W42 after passing through the second TCP 722. That is, the forty-second line width W42 includes an expanded portion W84 in addition to the first line width W1.

In addition to minimizing impedance of respective ones of the signal lines 80, that is, of the second signal line 82, the present exemplary embodiment minimizes the increase of impedance of the third and fourth signal lines 83 and 84. However, aspects of the present invention are not limited thereto and other signal lines 80 may increase in line width as they pass through respective ones of the TCPs 72.

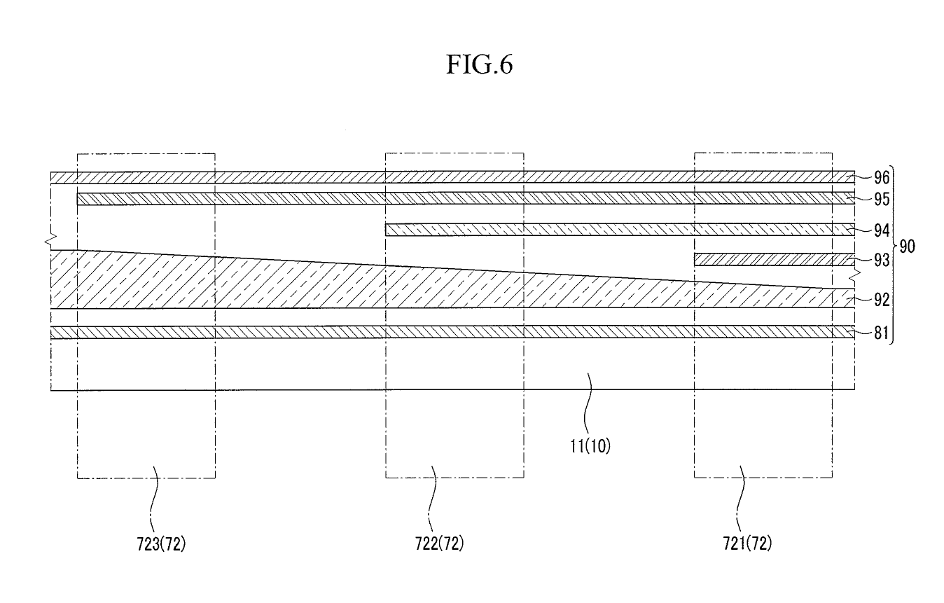

FIG. 6 is a top plan view schematically showing signal lines of which the line width changes, corresponding to flexible printed circuits (FPC), in a plasma display device according to yet another exemplary embodiment. For convenience, in FIG. 6, the connection structure between the TCPs 72 and the address electrode terminals 18 is not shown, and the number and width of the signal lines 90 respectively decreases and increases after passing through the TCPs 72.

The signal lines 90 according to the third exemplary embodiment includes first to fifth signal lines 91, 92, 93, 94, and 95, and the TCPs 72 include first to third TCPs 721, 722, and 723. In this configuration, the signal line 92 has a trapezoidal line shape with increasing width as the signal line 92 passes across the TCPs 72. The third signal line 93 is connected to and ends at the first TCP 721, the fourth signal line 94 is connected to and ends at the second TCP 722, and the fifth signal line 95 is connected to and ends at the third TCP 723. Therefore, the line width of the second signal line 92 gradually increases as it passes from the first TCP 721 to the third TCP 723.

The present exemplary embodiment minimizes the increase of impedance of the second signal line 92 by having an increasing line width of the second signal line 92 with a trapezoid shape. However, aspects of the present invention are not limited thereto and other signal lines 90 may have a trapezoidal shape with increasing line width.

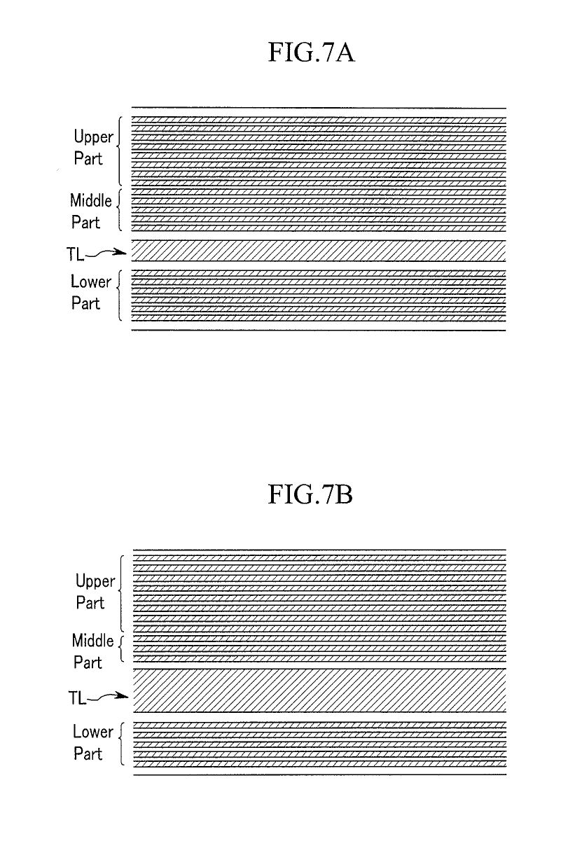

FIG. 7A and FIG. 7B show increases of line widths of the signal lines with corresponding decreases of the number of signal lines. FIG. 7A shows a pattern composed of twenty signal lines, which consist of upper part with 8 signal lines, middle part with 5 signal lines and lower part with 6 signal lines, and FIG. 7B shows that the pattern composed of seventeen signal lines, which consist of upper part with 8 signal lines, middle part with 3 signal lines and lower part with 5 signal lines, wherein the line width of one of the signal lines increases from 255 μm to 455 μm.

That is, comparing FIG. 7A with FIG. 7B, one of six signal lines under an target signal line TL is connected to and ends at a prior TCP 72, and two of five signal lines (middle part) above the target signal line TL are connected to and end at the prior TCP 72. Therefore, the target signal line TL is formed to have a largely expanded line width, thereby minimizing the increase of impedance.

Referring again to FIG. 2, the TCP 72 connected to the signal lines 60 is connected to the address electrode terminals 18, and applies address voltages and control signals generated from the driver IC 73 to the address electrodes 13 through the address electrode terminals 18. A sealing member 50 seals a joint of the signal lines 60 and the TCP 72 to protect them from an external environment.

Meanwhile, the driver IC 73 mounted in the TCP 72 is supported to a cover plate 75 by interposing a heat dissipation pad 74 or thermal grease (not shown). The cover plate 75 is fastened to a bent portion 33 of the chassis base 30 by a setscrew 32 to protect the TCP 72.

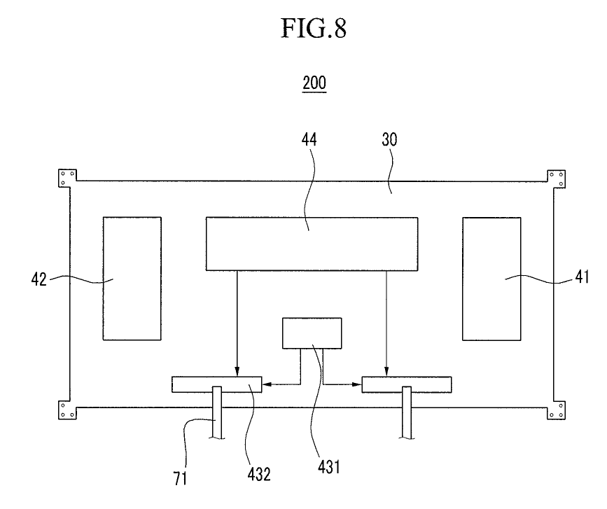

FIG. 8 is a rear view of a chassis base in a plasma display device according to another exemplary embodiment of the present invention. Referring to FIG. 8, a plasma display device 200 of the present exemplary embodiment, unlike the plasma display device 100 of the exemplary embodiment of FIG. 4, includes a miniboard assembly 432 that is formed by reducing a configuration of an existing address buffer board assembly.

In other words, the elements of an existing address buffer board assembly are formed on a logic board assembly 431, a miniboard assembly 432, and signal lines 60. Accordingly, compared with the exemplary embodiment of FIG. 4, the present exemplary embodiment is disadvantageous as per reducing the manufacturing cost, but decreases the manufacturing cost when compared with the configuration having an existing address buffer board assembly.

An address voltage, having a relatively high voltage, and control signals controlling the address electrode 13 are applied to the miniboard assembly 432 from the power supply board assembly 44. Therefore, the address voltage is applied from the miniboard assembly 432 to the address electrode 13 through the interface FPC 71, signal lines 60, and TCP 72.

A driver IC 73 ground, a driver IC 73 driving voltage, a driver IC control signal, a clock signal, and an address data signal, which are relatively low, are applied from the logic board assembly 431 to the miniboard assembly 432. Therefore, the control signals of the low voltage are applied from the miniboard assembly 432 to the TCP 72 and the driver IC 73 through the interface FPC 71 and power signal lines 60.

The present exemplary embodiment shows that it is possible to achieve the same effect of preventing an increase of the impedance as achieved in the previous exemplary embodiments. The increase of the impedance is prevented by providing the signal lines 60, 80, and 90 to the end of the PDP 10 when the miniboard assembly 432 is formed by having elements of an existing address buffer board assembly be formed on a logic board assembly 431, a miniboard assembly 432, and signal lines 60.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A plasma display device comprising:
a plasma display panel including a plurality of electrodes;
a printed circuit board assembly activating the plasma display panel; a chassis base, comprising:
a first surface supporting the plasma display panel, and
a second surface having the printed circuit board assembly;
signal lines applying a voltage, a data signal, and a control signal to the electrodes are formed at the end of the plasma display panel; and
an interface flexible printed circuit connecting the signal lines to the printed circuit board assembly, wherein, at least one of the signal lines has a line width at a portion further from the interface flexible printed circuit that is larger than a line width at a portion closer to the interface flexible printed circuit.

2. The plasma display device of claim 1, wherein the larger the number of signal lines passing through corresponding ones of flexible printed circuits from the interface flexible printed circuit is, the more the number of the signal lines decreases as the signal lines pass through the corresponding ones of the flexible printed circuits, and
in accordance with the decrease of the number of signal lines, at least one of the signal lines remaining after passing through the corresponding ones of the flexible printed circuits has a line width that increases after passing through the corresponding ones of the flexible printed circuits.

3. The plasma display device of claim 1, wherein at least one of the signal lines has a line width that increases in a step shape while passing through corresponding ones of flexible printed circuits.

4. The plasma display device of claim 3, wherein a signal line adjacent to the signal line having the step shape has an expanding portion increasing a line width of the adjacent signal line after the corresponding ones of the flexible printed circuits.

5. The plasma display device of claim 1, wherein at least one of the signal lines has a trapezoidal shape with a line width that increases while passing through corresponding ones of flexible printed circuits.

6. A plasma display device comprising:
a plasma display panel, comprising:
a front substrate,
a rear substrate,
a plurality of electrodes between the front substrate and the rear substrate, and
signal lines formed on the rear substrate apart from the plurality of electrodes and applying a voltage, a data signal, and a control signal to the electrodes;
a chassis base adjacent to the rear substrate;
a plurality of printed circuit board assemblies mounted on the chassis base; and
an interface flexible printed circuit connecting the signal lines to corresponding ones of the plurality of printed circuit board assemblies,
wherein at least one of the signal lines has a line width at a portion further from the interface flexible printed circuit that is larger than a line width at a portion closer to the interface flexible printed circuit.

7. The plasma display device of claim 6, wherein the larger the number of signal lines passing through corresponding ones of flexible printed circuits from the interface flexible printed circuit, the more the number of the signal lines decreases as the signal lines pass through the corresponding ones of the flexible printed circuits, and
in accordance with the decrease of the number of the signal lines, at least one of the signal lines remaining after passing through the corresponding ones of the flexible printed circuits has a line width that increases before passing the corresponding ones of the flexible printed circuits.

8. The plasma display device of claim 6, wherein at least one of the signal lines has a line width that increases in a step shape while passing through corresponding ones of flexible printed circuits.

9. The plasma display device of claim 8, wherein a signal line adjacent to the signal line having the step shape has an expanding portion that increases a signal line width of the adjacent signal line after the corresponding ones of the flexible printed circuits.

10. The plasma display device of claim 6, wherein at least one of the signal lines has a trapezoidal shape with a line width that increases while passing through corresponding ones of flexible printed circuits.

11. A plasma display device comprising:
a plasma display panel including a plurality of electrodes;
a printed circuit board assembly activating the plasma display panel, comprising:
a sustain board assembly,
a scan board assembly,
a logic board assembly,
a miniboard assembly, and
a power supply board assembly;
a chassis base supporting the plasma display panel at a first surface and having the printed circuit board assembly at a second surface;
signal lines applying a voltage, a data signal, and a control signal to an address electrode and formed at the end of the plasma display panel;
an interface flexible printed circuit connecting the signal lines to the miniboard assembly; and
a flexible printed circuit having a driver IC mounted thereon, the flexible printed circuit connecting the signal lines to the address electrode,
wherein the miniboard assembly is connected to the logic board assembly and controls an address electrode in the electrodes, and
wherein at least one of the signal lines has a line width at a portion further from the interface flexible printed circuit that is larger than a line width at a portion closer to the interface flexible printed circuit.

12. The plasma display device of claim 11, wherein at least one of the signal lines has a line width that increases in a step shape while passing through the flexible printed circuit.

13. The plasma display device of claim 11, wherein at least one of the signal lines has a trapezoidal shape with a line width that increases across the flexible printed circuit.

14. The plasma display device of claim 1, wherein the printed circuit board assembly is plural in number.

15. A plasma display panel of a plasma display device having a chassis base and printed circuit board assemblies disposed on the chassis base, the plasma display panel comprising:
a front substrate;
a rear substrate opposing the front substrate;
address electrodes disposed between the front substrate and the rear substrate;
address electrode terminals connected to the address electrodes;
signal lines applying a voltage, a data signal, and a control signal to the address electrodes and formed at the end of the rear substrate;
an interface flexible printed circuit (FPC) connecting the signal lines to the printed circuit board assemblies; and
tape carrier packages having a driver integrated circuit and connecting the address electrodes to the signal lines through the address electrode terminals,
wherein at least one of the signal lines has a line width at a portion further from the interface flexible printed circuit that is larger than a line width at a portion closer to the interface flexible printed circuit.

16. The plasma display panel of claim 15, wherein at least one of the signal lines has a line width that increases in a step shape while passing through the tape carrier packages.

17. The plasma display device of claim 16, wherein a signal line adjacent to the signal line having the step shape has an expanding portion that increases a signal line width of the adjacent signal line across the flexible printed circuit.

18. The plasma display panel of claim 15, wherein at least one of the signal lines has a trapezoidal shape with a line width that increases across the flexible printed circuit.

19. The plasma display panel of claim 15, wherein the larger the number of signal lines passing through the tape carrier packages from the interface flexible printed circuit, the more the number of the signal lines decreases as the signal lines pass through the tape carrier packages, and
in accordance with the decrease of the number of the signal lines, at least one of the signal lines remaining after passing through a respective one of the tape carrier packages has a line width that increases after passing through the respective one of the tape carrier packages.
